(19) United States
(12) Patent Application Publication
(10) Pub. No.: US 2025/0077979 A1
(43) Pub. Date: Mar. 6, 2025

(54) METHOD AND APPARATUS FOR ON-DEVICE PERSONALISED ANALYSIS USING A MACHINE LEARNING MODEL

(71) Applicant: SAMSUNG ELECTRONICS CO., LTD., Suwon-si (KR)

(72) Inventors: Da LI, Middlesex (GB); Ondrej BOHDAL, Middlesex (GB); Timothy HOSPEDALES, Middlesex (GB); Xu HU, Middlesex (GB)

(73) Assignee: SAMSUNG ELECTRONICS CO., LTD., Suwon-si (KR)

(21) Appl. No.: 18/952,216

(22) Filed: Nov. 19, 2024

Related U.S. Application Data
(63) Continuation of application No. PCT/KR2023/006858, filed on May 19, 2023.

(30) Foreign Application Priority Data
May 19, 2022 (GB) 2207373.8
May 11, 2023 (GB) 2306958.9

(51) Int. Cl. G06N 20/00; H04L 67/04; H04L 67/306

(52) U.S. Cl. CPC G06N 20/00; H04L 67/04; H04L 67/306

(57) ABSTRACT

Broadly speaking, the present techniques generally relate a method and apparatus for on-device personalisation of artificial intelligence models. In particular, the present application relates to a computer-implemented method for performing personalised visual or audio analysis on an electronic device using a trained machine learning, ML, model.

### TECHNICAL FIELD

The present application generally relates to a method and apparatus for on-device personalisation of artificial intelligence, AI, or machine learning, ML, models. In particular, the present application relates to a computer-implemented method for performing personalised visual or audio analysis on an electronic device using a trained machine learning, ML, model.

### BACKGROUND ART

The current paradigm for deploying deep-learning artificial intelligence, AI, models (such as automatic speech recognition, object recognition, etc.) on mobile devices is to train models in the cloud on reference data, before deploying the model on device where the model is frozen and no longer updated.

However, users' data is inevitably different to the reference distribution used for training, resulting in worse than expected performance and dissatisfied users.

Emerging on-device personalized adaptation techniques attempt to mitigate this issue by learning from, potentially unlabelled, user data on device. But these have several key limitations, including: (i) They require backpropagation-based optimization, which is too costly for mobile devices, and not supported by software frameworks such as tflite (TensorFlow Lite). (ii) They assume that all the unlabelled user data is similarly distributed and domain-relevant to each test instance. This assumption is violated in practice and leads to poor adaptation performance.

Domain shift presents a real-world challenge for the application of machine learning, ML, models because performance degrades when deployment data are not from the training data distribution. For example, a model that has been only trained on day-time images will perform poorly when presented with night-time images. This issue is ubiquitous, as it is often impossible or prohibitively costly to pre-collect and annotate training data that is sufficiently representative of test data statistics. The field of domain adaptation has therefore attracted a lot of attention with the promise of adapting models during deployment to perform well using only unlabelled deployment data.

Therefore, the present applicant has recognised the need for an improved technique for on-device personalisation of AI models.

### DISCLOSURE

### Technical Solution

In a first approach of the present techniques, there is provided a computer-implemented method for performing personalised visual or audio analysis, on an electronic device using a trained machine learning, ML, model, the method comprising: receiving a query data item for analysis by the trained ML model; comparing the received query data item with a plurality of support data items stored on the electronic device to determine a similarity between the received query data item and each of the support data items; and performing personalised analysis on the received query data item, using the trained ML model, using the data item and the determined similarities.

The term “support data items” is used herein to mean data items saved by the electronic device. The support data items may be captured by the electronic device, or may be received by the electronic device and saved. In some cases, the electronic device is an autonomous electronic device, such as a virtual assistant device or a robotic device. In other cases, the electronic device may be a user device such as a smartphone. In both cases, the support data items may be captured by the electronic device or provided to the electronic device by a user of the electronic device. The support data items form a dataset that may be more representative of the environment in which the electronic device is being used. For example, the support data items may be images of the interior of a user's home. While the ML model may have been trained using images of the interiors of homes, it has not been trained on images of the user's home. Thus, the present techniques enable the ML model to be personalised by making use of the support data items.

Advantageously, the present techniques enable a trained ML model to be adapted to new data on-device, i.e. on a constrained electronic device such as a smartphone, without requiring access to all the original data that has been used to train the ML model, without requiring users' personal data to be shared, and without using the computationally expensive training approach of backpropagation. User's may not wish for their personal data, including images captured of them, their family members, their belongings, their home, and so on, to be shared with third parties.

Existing techniques for performing adaptation of a ML model require backpropagation, which is computationally expensive, such that it may not be possible to implement on constrained resource devices, such as smartphones and virtual assistant devices. Another advantage of the present techniques is that backpropagation is not required to personalise the ML model. Furthermore, no access to the original training data used to train the ML model is required, which again makes the adaption possible on constrained resource devices. Instead, the present techniques make use of the support data items, which are local to the device on which the ML model is being adapted and used. The present techniques use the similarity between the received query data item (which needs to be processed by the ML model) and the support data items to perform the personalised analysis by the ML model.

The “similarity” being determined with respect to each support data item may be a measure of how similar that support data item is to the received query data item. For example, the similarity may be determined by calculating a dot product value between two features (one from the query data item, one from the support data item). Thus, the “similarity” could indicate that the support data item is very similar, not very similar/completely dissimilar, and anything in between. To determine the similarity between the received query data item and each of the support data items, the method may further comprise: extracting, using a feature extractor of the trained ML model, at least one feature from the received query data item and at least one feature from each of the plurality of support data items. The comparing may comprise: using a trained cross-attention module of the trained ML model to determine a similarity between the received query data item and each of the support data items, using the extracted features. The cross-attention module may have been trained to determine the correlations or similarities between features of samples/data items.

The support data items may be projected into keys and values. The features of the query data item may be regenerated using the cross-attention module. This is because query data items act as queries for cross-attention after transformation by a projection matrix. After calculating an attention map representing the similarities between queries and keys and applying the attention map to the values, the output of the cross-attention module may be multiplied by a further projection matrix. Thus, the method may further comprise using the cross-attention module to generate features of each query data item using the selected at least one support data item that is most similar, wherein the generated features are input into a classifier module of the ML model. In other words, prior to being input into the classifier module, the feature of a query data item may be generated using, for example, the cross-attention module with the above-mentioned further projection matrix.

As part of determining the similarities, the support data item(s) with the most features in common with the received query data item may be indicated or output in some way. This is because, as explained in more detail below with respect to the Figures, once the similarities between the received query data item and the support data items have been determined (by the cross-attention module), the similarities may be used to generate a feature representation for the received query data item, to enable the personalized analysis to be performed. This may comprise generating a (normalized) similarity vector using one or more relevant features of the support data items. Thus, the method may comprise generating, using the determined similarities, a feature representation for the received query data item for use by the trained ML model to perform personalised analysis on the received query data item.

The relevant features of the support data items may be the features that are similar to feature(s) of the received query data item, for example. The one or more relevant features may be combined with feature(s) of the received query data item, or be used to transform the received query data item's vanilla feature(s) to a new feature(s). That is, the features of the support data item(s) with the most similarities may be selected or weighed such that these features contribute more to making a prediction with respect to the received query data item. Thus, the generating may comprise using the feature(s) from at least one support data item to modify the extracted features of the received query data item, wherein the feature(s) from the at least one support data item that is similar to the received query data item. The at least one support data item that is similar to the received query data item may be support data item(s) that has the most features in common with, or is most similar to, the received query data item, for example. Alternatively, the similar support data item(s) may be that/those which are somehow helpful for the received query data to perform the personalised analysis, e.g. those with high feature similarity.

In some cases, the received query data item and the support data items may contain meta-data. For example, the meta-data may be GPS coordinates or other location information, time and/or date information (e.g. time stamps), and so on. It will be understood that these are non-limiting example types of metadata. Such meta-data may be used to improve adaptation by extending the cross-attention module of the ML model. Thus, the meta-data may be used to determine which of the support data items are similar to the received query data item. Determining the similarities, using a trained cross-attention module, may therefore comprise: comparing meta-data of each support data item with meta-data of the received query data item. The meta-data may be combined with the features extracted from the corresponding data item. For example, the meta-data associated with a data item may be fused or concatenated with the feature(s) extracted from that data item. Then, determining the similarities comprises determining the similarities between the fused/concatenated features of the received query data item and the support data items. That is, the method may further comprise: concatenating the meta-data of each support data item with the extracted feature for the support data item, and concatenating the meta-data of the received query data item with the extracted feature of the query data item; wherein using a trained cross-attention module to determine the similarities comprises using the trained cross-attention module to compare the extracted features that are concatenated with the meta-data.

As mentioned above, the feature representation for the received query data item incorporates information about the features of the received query data item as well as information about the support data item(s) that is (are) similar to the received query data item. The feature representation may incorporate information from the similar support data item(s) by weighting coefficients of features in the feature representation based on how similar the features are to features of the support data item(s). The more similar a feature of a support data item is to a feature of the received query data item, the higher the weight of the corresponding coefficient. This generated feature representation is then used by the ML model to perform personalised analysis on the received data item. For example, the ML model may make a prediction or predictions with respect to the received query data item, using the generated feature representation.

In cases when no support data item is determined as being suitable for use by the trained ML model (e.g. because no support data item has sufficient feature similarity with the received query data item), the personalised analysis may be performed using the trained ML model and the received query data item only. This prevents negative transfer. That is, when none of the support data items are relevant (e.g. similar to the received query data item), using any of the support data items may lead to detrimental adaptation of the ML model. The present techniques avoid this by reverting to the “factory setting”, i.e. processing the original features of the received query data item (without information taken from the support data items).

As noted above, the method comprises comparing the received query data item with a plurality of support data items. In some cases, comparing the received query data item with a plurality of support data items stored on the electronic device may comprise using all of the plurality of support data items that are available. This may be possible when the number of support data items is small enough that the ML model can perform the comparing steps without impacting a required or target inference/processing speed. In other words, all of the support data items may be used when latency is not impacted.

Alternatively, comparing the received query data item with a plurality of support data items stored on the electronic device may comprise using a subset of the plurality of support data items when using all of the plurality of support data items would increase a time required to perform the comparing. This may be useful when the amount/number of total available support data items is too big, such that the latency of the ML model is negatively impacted. The subset of support data items may be obtained by randomly selecting a predefined number of support data items from the plurality stored on the electronic device. Alternatively, the subset of support data items may be obtained by selecting a predefined number of the most recently stored support data items, e.g. using a First In First Out (FIFO) or Last In First Out (LIFO) method.

The plurality of support data items stored on the electronic device may be unlabelled data items. The trained ML model may have been trained by using unlabelled support data items, which is advantageous because at the inference time the support data items available on the electronic device may not be labelled.

In some cases, the received data item may be an image, the plurality of support data items may be images, and the trained ML model may be trained to perform image analysis. In such cases, the trained ML model may be trained to perform any one of the following image analysis tasks: image classification, object recognition, semantic segmentation, grasp prediction, navigation, and image enhancement. It will be understood that this is a non-limiting and non-exhaustive list of example image analysis tasks.

In other cases, the received data item may be an audio data item, the plurality of support data items may be audio files, and the trained ML model may be trained to perform audio analysis. In such cases, the trained ML model may be trained to perform any one of the following audio analysis tasks: automatic speech recognition, audio enhancement, noise suppression, and language translation. It will be understood that this is a non-limiting and non-exhaustive list of example audio analysis tasks.

In a second approach of the present techniques, there is provided an electronic apparatus for performing personalised visual or audio analysis using a trained machine learning, ML, model, the apparatus comprising: at least one processor coupled to memory and arranged to: receive a query data item for analysis by the trained ML model; compare the received query data item with a plurality of support data items stored on the electronic device to determine a similarity between the received query data item and each of the support data items; and perform personalised analysis on the received query data item, using the trained ML model, the support data items and the determined similarities.

The features described above with respect to the first approach apply equally to the second approach, and for the sake of conciseness are not repeated.

The electronic apparatus may be a constrained-resource device, but which has the minimum hardware capabilities to use a trained neural network/ML model. The apparatus may be: a smartphone, tablet, laptop, computer or computing device, virtual assistant device, a vehicle, a drone, an autonomous vehicle, a robot or robotic device, a robotic assistant, image capture system or device, an augmented reality system or device, a virtual reality system or device, a gaming system, an Internet of Things device, a smart consumer device, a smartwatch, a fitness tracker, and a wearable device. It will be understood that this is a non-exhaustive and non-limiting list of example apparatus.

In a third approach of the present techniques, there is provided a computer-implemented method to train, using a server, a machine learning, ML, model to perform personalised visual or audio analysis, the method comprising: obtaining a first training dataset comprising a plurality of query data items that represent data items to be analysed by the ML model, and a second training dataset comprising a plurality of support data items that represent data items with varying degrees of similarity to the query data items; and inputting tuples of data items comprising data items from each of the first and second training datasets, and training the cross-attention module to: compare, for each tuple, a feature of the query data item and features of the support data item(s); and select, using the comparing, at least one support data item that is most similar to each query data item. The term “tuple” is used herein to mean a set of two or more elements. In some cases, the tuple may have two elements, i.e. a data item taken from each of the first and second training datasets. In other cases, the tuple may have more than two elements, i.e. a data item taken from the first training dataset, and a set of support data items taken from the second training dataset. As explained below, once selected, the at least one feature of the query data item may be transformed using the cross-attention module and the features of the support data items.

To determine the similarity between the query data item and the support data item(s) in each tuple, the method may comprise extracting, using a feature extractor, the feature from each data item in the tuple. In some cases, the data items in the tuple may contain or comprise meta-data. For example, the meta-data may be location information, or time and/or date information. To make use of this meta-data during the training, the meta-data of a data item may be concatenated with the extracted feature(s) of that data item. The method may then further comprise training the cross-attention module to compare the extracted feature(s) of the query data item that are concatenated with meta-data of the query data item, and the extracted features of the support data items that are concatenated with their meta-data.

Comparing features of the query data item and support data item may comprise comparing the query and support data items as whole data items. For example, in the case of the data items in each tuple being images, the training method may comprise comparing the images, rather than comparing patches of the images. A benefit of image-to-image attention is also that it is significantly more efficient—the whole image is attended to rather than patches, which makes the overall computations manageable even with more images.

The support data items may be projected into keys and values. The features of the query data item may be generated using the cross-attention module. This is because query data items act as queries for cross-attention after transformation by a projection matrix. After calculating the attention map and applying the attention map to the values, the output of the cross-attention module is multiplied by a further projection matrix. Thus, the method may further comprise training the cross-attention module to generate a feature representation of each query data item using the selected at least one support data item that is most similar, wherein the generated feature representation is input into a classifier module of the ML model. In other words, prior to being input into the classifier module, the feature representation of a query data item may be generated using, for example, the cross-attention module with the above-mentioned further projection matrix.

The method may further comprise training the cross-attention module to not generate a feature representation of a query data item when no support data item is identified as being similar. This is useful because it avoids or prevents negative transfer. That is, when none of the support data items are relevant (e.g. similar to the query data item), using any of the support data items may lead to detrimental adaptation of the ML model. The present techniques avoid this by processing a query data item without information taken from the support data items in cases when the support data items are dissimilar to the query data item.

In some cases, the support data items and query data items may be images, and the ML model may be trained to perform image analysis.

In other cases, the support data items and query data items may be audio files, and the ML model may be trained to perform audio analysis.

In a related approach of the present techniques, there is provided a computer-readable storage medium comprising instructions which, when executed by a processor, causes the processor to carry out any of the methods described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog® or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

The methods described above may be wholly or partly performed on an apparatus, i.e. an electronic device, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, the present techniques may be implemented using an AI model. A function associated with AI may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

### DESCRIPTION OF DRAWINGS

Implementations of the present techniques will now be described, by way of example only, with reference to the accompanying drawings, in which:

FIG. 1 is a schematic diagram illustrating the training and personalisation process of the present techniques;

FIG. 2 is a schematic diagram illustrating how self-attention and cross-attention work;

FIG. 3 illustrates how latent domain adaption tasks are structured, and how the structure compares to standard domain adaption;

FIG. 4 is a schematic diagram illustrating the inference method of the present techniques;

FIG. 5 shows an algorithm for episodic meta-learning for source-free latent domain adaption;

FIG. 6 is a table showing experimental results comparing the present techniques with existing models;

FIG. 7 is a table showing the experimental performance of the present techniques with unsupervised and supervised cross-attention;

FIG. 8 is a table showing average inference time in milliseconds of each task for the present techniques and existing models;

FIG. 9 is a table showing total run time in minutes of the present techniques and existing models;

FIGS. 10A and 10B show how robotic devices may process data from a variety of sensors for a variety of tasks;

FIG. 10C shows how the present techniques may be used to enhance the functionality of a robot device;

FIG. 11A shows how smartphones may process data from a variety of sensors for a variety of tasks;

FIG. 11B shows how the present techniques may be used to enhance the functionality of a smartphone;

FIG. 12 is a flowchart of example steps to train a model that is capable of adaptation;

FIG. 13 is a flowchart of example steps to dynamically adapt the trained model at inference time on-device; and

FIG. 14 is a block diagram of a system for training and using a model that is adaptable on-device.

### MODE FOR INVENTION

Broadly speaking, the present techniques generally relate a method and apparatus for on-device personalisation of artificial intelligence models. In particular, the present application relates to a computer-implemented method for performing personalised visual or audio analysis on an electronic device using a trained machine learning, ML, model.

Domain shift presents a real-world challenge for the application of machine learning models because performance of the models degrades when deployment data (i.e. the data being processed by the models at run/inference time) are not from the training data distribution (i.e. the data used to train the models). For example, a model that has been only trained on day-time images will perform poorly when presented with night-time images. This issue is ubiquitous as it is often impossible or prohibitively costly to pre-collect and annotate training data that is sufficiently representative of test data statistics. The field of domain adaptation has therefore attracted a lot of attention with the promise of adapting models during deployment to perform well using only unlabelled deployment data.

Source-free domain adaptation (SFDA) has emerged as a practical scenario where no source data are available during adaptation and a pre-trained model is adapted to target domain data. It has been observed that unsupervised domain adaptation can be done even without access to the source data and a method called SHOT has been proposed. SHOT utilizes information maximization and self-supervised pseudo-labelling to align target and source domain representations. In fact, most SFDA methods use pseudo-labels—soft labels predicted by the pretrained model—as the basis for adapting the model. Further recent approaches include 3C-GAN and NRC. 3C-GAN synthesizes labelled target-style training images based on the conditional GAN to provide supervision for adaptation, while NRC does a neighbour-based update for SFDA that uses reciprocal nearest neighbours for thresholding noisy updates. SFDA has also been applied to semantic segmentation and object detection problems. SFDA in general is regarded as a highly challenging domain adaptation scenario, but as one of high practical value because it does not require access to source data.

Test-time domain adaptation (TTDA) is related to SFDA and focuses on directly adapting to the specific mini-batch at test time. A meta-learning framework for TTDA has been recently proposed under the name adaptive risk minimization (ARM). ARM provides a variety of options for how TTDA is done, including context network that embeds information from the whole minibatch, updates to batch normalization statistics and gradient-based fine-tuning on the minibatch. ARM learns to do TTDA by meta-learning across a large number of tasks.

The present techniques provide a new framework that uses feed forward operators only during personalization, which makes it easily apply to all device tiers (i.e. devices of differing hardware specification, such as differing processing capability). The framework adapts by using unlabelled auxiliary data, which need not be completely domain-relevant to the test-instance.

The present applicant makes two main contributions: a conceptual contribution, framing domain adaptation in a new highly practical way; and an algorithm for effective domain adaptation in these conditions.

Latent domain adaptation: While domain adaptation is now very well studied, the vast majority of work assumes that suitable meta-data is available in order to correctly group instances into one or more subsets (domains) that differ statistically across groups, while being similar within groups. However, this is arguably an overly restrictive assumption that does not hold in most real applications of interest. On one hand some datasets or collection processes may not provide meta-data suitable for defining domain groupings. Alternatively, for other data sources that occur with rich meta-data there may be no obviously correct grouping and existing domain definitions may be sub-optimal. Consider the popular iWildCam (Sara Beery, Elijah Cole, and Arvi Gjoka. The iwildcam 2020 competition dataset. CoRR, abs/2004.10340, 2020) benchmark for animal detection within the WILDS suite. The default setup within WILDS defines domains by camera ID. But given that images span different weather conditions and day/night cycles, such domains may neither be internally homogenous, nor similarly distinct. For example there may be more transferability between images from nearby cameras at similar times of day than between images from the same camera taken on a sunny day versus a snowy night. As remarked by some, domains may more naturally define a continuum, rather than discrete groups, and that continuum may even be multi-dimensional-such as timestamp of image and spatial proximity of cameras. In contrast, the present techniques propose a flexible formulation of the domain adaptation problem that can span all these situations where domains are hard to define, while aligning with the requirements of real use cases.

Feed-forward and source-free conditions: Unsupervised domain adaptation aims to adapt models from source datasets (e.g. ImageNet) to the peculiarities of specific data distributions in the wild. The mainstream line of work here uses labelled source domain data alongside unlabelled target domain data and updates the model so it performs well on the target domain using backpropagation. However the key use cases motivating domain adaptation are edge devices such as autonomous vehicles, smartphones, and hospital scanners. Storing and processing large source datasets on such devices is usually infeasible. This has led a growing number of studies to investigate the source-free condition, where a pre-trained model is distributed and adapted using solely unlabelled target data.

The present applicant has further considered the practical requirements of an edge device, namely that most edge devices are not designed in either hardware or software stack to support backpropagation. Thus, the present applicant has focused on the feed-forward condition where adaptation algorithms should proceed using only feed-forward operations. For example, simply updating batch normalisation statistics, which can be done without back-propagation, provides a strong baseline for adaptation.

Feed-forward source-free latent domain adaptation. Bringing these ideas together, the present applicant envisages a setup where edge devices maintain an unlabelled target dataset that need not be a cleanly meta-data induced domain in the conventional sense, but which may contain examples relevant to the inference of test instances. Instances in the target set may be of varied relevance to a given test instance. E.g., if true instance relevance is a function of timestamp similarity. These target examples should then drive model adaptation on the fly, leveraging neither source data, nor back-propagation.

Transformers. As will be described in more detail below, the present techniques use cross-attention, which takes inspiration from the attention mechanism found in the transformer architecture of Vaswani et al. After transformers became common in NLP, they have also led to strong results within computer vision, most prominently as part of the ViT model. ViT model has served as foundation for more recent vision transformers, including CrossViT that combines strong performance with efficiency. The cross-attention mechanism from CrossViT served as the initial starting point for the design of the present cross-attention module. The present techniques have been inspired by the idea of non-parametric transformers that are able to reason about relationships between data points. As explained below, the present applicant shows how the attention mechanism can be used to perform source-free latent domain adaptation in a feed-forward way.

To solve the challenge posed above, the present techniques provide a feed-forward adaptation framework based on cross-attention between test instances and the target set. The cross-attention module is meta-learned based on a set of training domains, inspired by Zhang et al. During deployment it flexibly enables each inference operation to draw upon any part of the target set, exploiting each target instance to a continuous degree. For example, this could potentially exclude transfer from target instances that would be conventionally in-domain (e.g., same camera/opposite time of day example earlier), include transfer from target instances that would conventionally be out-of-domain (e.g., similar images/different camera example earlier), and continuously weight similarity to each target image (e.g., temporal distance of images taken in sequence). Experiments show that the pre-set cross-attention approach provides useful adaptation in this highly practical setting across a variety of synthetic and real benchmarks.

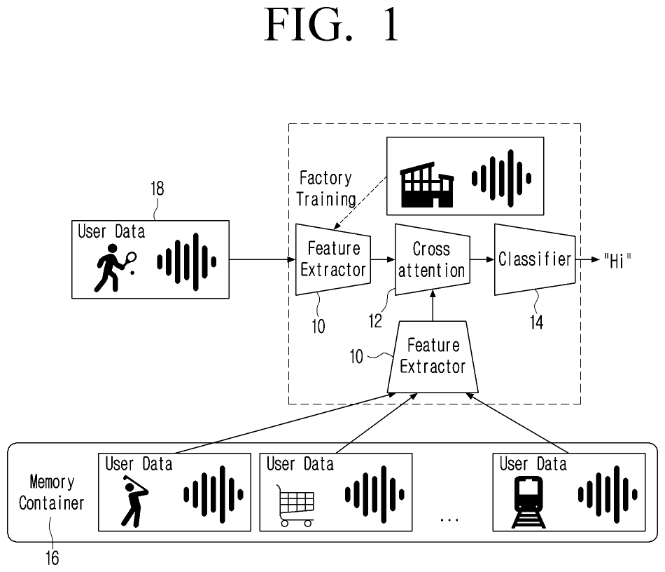

FIG. 1 is a schematic diagram illustrating the training and personalisation process of the present techniques. The present techniques are also referred to herein as “feed-forward on-device personalization” techniques. Feed-forward on-device personalization addresses updating artificial intelligence, AI, or machine learning, ML, models on device in order to increase their accuracy on each user's specific distribution of data with only efficient feed-forward operators. Adaptation advantageously happens automatically and transparently during normal use without privacy risk of sending data to the cloud. Adaptation happens efficiently on-the-fly without need for the cost or latency of an overnight “plug-in” phase; without the need for storing reference training data on device; and without needing to support backprop in software or hardware stack.

Specifically, in FIG. 1, the basic ML model (shown in the dashed box) is loaded onto the device during production, including a feature extractor 10, a cross-attention module 12 and a classifier module 14, together with a memory container 16 to store unlabelled user data, also referred to herein as “support data” or “support data items”.

After deployment, users can upload unlabelled data from their daily routines to the memory container, or choose to enable automatic sharing of a sliding window of their recent data into the memory container.

In applications where the user experiences diverse data distributions (e.g., home, office, sports, commute environments etc.), all this data can be stored in the memory container 16.

Once there is support data cached in the memory container 16 for different environments, it will be used to improve inference accuracy (classification, detection, etc) of the new data (aka “query data”) from the same or similar environments by the cross-attention module 12.

Unlike all existing adaptation solutions, this process (i) does not require backpropagation and can occur in real-time, (ii) does not rely on all support data being relevant.

Thus, the present techniques provide a computer-implemented method for performing personalised visual or audio analysis, on an electronic device using a trained machine learning, ML, model, the method comprising: receiving a query data item 18 for analysis by the trained ML model; comparing the received query data item 18 with a plurality of support data items 16 stored on the electronic device to determine a similarity between the received query data item and each of the support data items; and performing personalised analysis on the received query data item, using the trained ML model, the support data items and the determined similarities.

In case the user enters a completely novel environment for which there is no suitable support data at all. This can be detected by checking the maximum correlation/similarity value outputted by the cross-attention module. The AI model switches back to the factory configuration. This ensures that performance is always at least as good as today's AI models.

FIG. 1, and the feed-forward on-device user personalisation, is now explained using automatic speech recognition, ASR, as an illustrative example. In this case, the basic modules (dashed box) of the neural network of the AI/ML model are trained in the factory using a range of data types (e.g., accents, noise conditions). A user uses their ASR module as usual on their electronic device, e.g. a smartphone. A buffer of recent audio is stored in the memory container. New utterances are transcribed with improved accuracy through cross-attention between test instance and the memory container.

There are several problems to achieving on-device personalized adaptation efficiently and flexibly. For example:

Computation: most adaptation/personalization approaches for deep neural networks require back-propagation during model adaptation, which is often slow or intractable to perform on devices with limited compute or battery power, such as mobile phones and TVs. It is also extremely difficult and costly to implement as standard on-device software frameworks such as tensorflow-lite do not (or weakly) support backpropagation.

Latency: Existing personalization/adaptation approaches require the adaptation data to be provided in batch form and an associated high-latency training phase on the given adaptation data. They do not support continual low-latency adaptation to a non-stationary stream of data. For example, in existing setups, adaptation to novel environments may happen the next day after an overnight training phase. With the present techniques, adaptation to novel environments can happen in real time, e.g., as a user walks between office and home.

Robustness: Besides slow model adaptation, most back-propagation approaches to personalization systems assume that the batch of adaptation data is known to be relevant to the current operating environment of the user. They are not flexible enough to support (i) continually evolving environments where the relevance of adaptation data to test data varies over time, or (ii) adaptation data that contains a mixture of situation relevant and situation irrelevant examples.

Source free: Most back-propagation approaches require that the reference data used for initial training prior to deployment is also utilized during adaptation. However, such reference datasets are likely large and impossible to store on user devices, occurs huge additional cost to process during adaptation, and such redistribution may suffer from licensing issues.

Memory: Neural network models themselves are large and often even require extra parameters to be introduced and saved during the model personalization. This is again a problem on resource limited devices.

All these problems are solved by the present techniques.

Inference Time. The adaptation of the trained ML model on an electronic device is first described.

As mentioned above, existing techniques for performing adaptation of a ML model require backpropagation, which is computationally expensive, such that it may not be possible to implement on constrained resource devices, such as smartphones and virtual assistant devices. Another advantage of the present techniques is that backpropagation is not required to personalise the ML model. Furthermore, no access to the original training data used to train the ML model is required, which again makes the adaption possible on constrained resource devices. Instead, the present techniques make use of the support data items, which are local to the device on which the ML model is being adapted and used. The present techniques use the similarities between the received query data item 18 (which needs to be processed by the ML model) and the support data items in the memory container 16 to perform the personalised analysis by the ML model.

To determine the similarities between the received query data item 18 and the support data items in the memory container 16, the method may further comprise: extracting, using a feature extractor 10 of the trained ML model, features from the received query data item and the plurality of support data items.

The comparing may comprise: using a trained cross-attention module 12 of the trained ML model to determine the similarities between the received query data item and the support data items. The cross-attention module 12 may have been trained to determine the correlations or similarities between features of samples/data items.

Once the similarities have been determined, the similarities may be used to generate a feature representation for the received query data item which will be used to perform the personalised analysis of the received query data item. This may comprise generating a (normalized) similarity vector using one or more relevant features of the support data items. Thus, the method may comprise generating, using the determined similarities, a feature representation for the received query data item for use by the trained ML model to perform personalised analysis on the received query data item.

The relevant features of the support data items may be the features that are similar to feature(s) of the received query data item, for example. The one or more relevant features may be combined with feature(s) of the received query data item, or be used to transform the received query data item's vanilla feature(s) to a new feature(s). That is, the features of the support data item(s) with the most similarities may be selected or weighed such that these features contribute more to making a prediction with respect to the received query data item. Thus, the generating may comprise using the feature(s) from at least one support data item to modify the extracted features of the received query data item, wherein the feature(s) from the at least one support data item that is similar to the received query data item. The at least one support data item that is similar to the received query data item may be support data item(s) that has the most features in common with, or is most similar to, the received query data item, for example. Alternatively, the similar support data item(s) may be that/those which are somehow helpful for the received query data to perform the personalised analysis, e.g. those with high feature similarity.

In some cases, the received query data item and the support data items may contain meta-data. For example, the meta-data may be GPS coordinates or other location information, time and/or date information (e.g. time stamps), and so on. It will be understood that these are non-limiting example types of metadata. Such meta-data may be used to improve adaptation by extending the cross-attention module of the ML model. Thus, the meta-data may be used to determine which of the support data items are similar to the received query data item. Determining the at least one similarity, using a trained cross-attention module, may therefore comprise: comparing meta-data of each support data item with meta-data of the received query data item. The meta-data may be combined with the features extracted from the corresponding data item. For example, the meta-data associated with a data item may be fused or concatenated with the feature(s) extracted from that data item. Then, determining the similarities comprises determining the similarities between the fused/concatenated features of the received query data item and each support data items. That is, the method may further comprise: concatenating the meta-data of each support data item with the at least one extracted feature for the support data item, and concatenating the meta-data of the received query data item with the at least one extracted feature of the query data item; wherein using a trained cross-attention module to determine the at least one similarity comprises using the trained cross-attention module to compare the extracted features that are concatenated with the meta-data.

As mentioned above, the new feature representation for the received query data item incorporates information about the features of the received query data item as well as information about the selected support data item(s) that is (are) similar to the received query data item. The feature representation may incorporate information from the similar support data item(s) by weighting coefficients of features in the feature representation based on how similar the features are to features of the support data item(s). The more similar a feature of the support data item is to a feature of the received query data item, the higher the weight of the corresponding coefficient. This generated feature representation is then used by the ML model to perform personalised analysis of the received data item. For example, the ML model may make a prediction or predictions with respect to the received query data item, using the generated feature representation. In other words, to enable relevant support data items to be used in the processing of the received query data item, the cross-attention module 12 computes an instance-to-instance feature correlation vector between the received query data item and the support data items. The cross-attention module 12 generates a feature representation for the received query data item which is then classified. The cross-attention module 12 has been trained to learn to use relevant support data items and extract information from them to correctly classify received query data items.

In cases when no support data item is determined as being suitable for use by the trained ML model, (e.g. because no support data item has a sufficient feature similarity with the received query data item), the personalised analysis may be performed using the trained ML model and the received query data item only. This prevents negative transfer. That is, when none of the support data items are relevant, using any of the support data items may lead to detrimental adaptation of the ML model. The present techniques avoid this by reverting to the “factory setting”, i.e. processing the original features of the received query data item (without information taken from the support data items).

In some cases, comparing the received query data item with a plurality of support data items stored on the electronic device may comprise using all of the plurality of support data items. This may be possible when the number of support data items is small enough that the ML model can perform the comparing steps without impacting a required or target inference/processing speed. In other words, all of the support data items may be used when latency is not impacted.

Alternatively, comparing the received query data item with a plurality of support data items stored on the electronic device may comprise using a subset of the plurality of support data items when using all of the plurality of support data items would increase a time required to perform the comparing. This may be useful when the total available number or amount of support data items is too big, such that the latency of the ML model is negatively impacted. The subset of support data items may be obtained by randomly selecting a predefined number of support data items from the plurality stored on the electronic device. Alternatively, the subset of support data items may be obtained by selecting a predefined number of the most recently stored support data items, e.g. using a First In First Out (FIFO) or Last In First Out (LIFO) method.

The plurality of support data items stored on the electronic device may be unlabelled data items. The trained ML model may have been trained using unlabelled data items, which is advantageous because the support data items available on the electronic device may not be labelled.

In some cases, the received data item may be an image, the plurality of support data items may be images, and the trained ML model may be trained to perform image analysis. In such cases, the trained ML model may be trained to perform any one of the following image analysis tasks: image classification, object recognition, semantic segmentation, grasp prediction, navigation, and image enhancement. It will be understood that this is a non-limiting list of example image analysis tasks.

In other cases, the received data item may be an audio data item, the plurality of support data items may be audio files, and the trained ML model may be trained to perform audio analysis. In such cases, the trained ML model may be trained to perform any one of the following audio analysis tasks: automatic speech recognition, audio enhancement, noise suppression, and language translation. It will be understood that this is a non-limiting list of example audio analysis tasks.

Training Time. The training of the ML model is now described, as well as the architecture of the ML model. This process preferably happens off-device, i.e. on a central server, so that the trained model may be trained once and deployed on many devices.

Generally speaking, a cross-attention module is inserted into a backbone model before the classifier layer/module of the model.

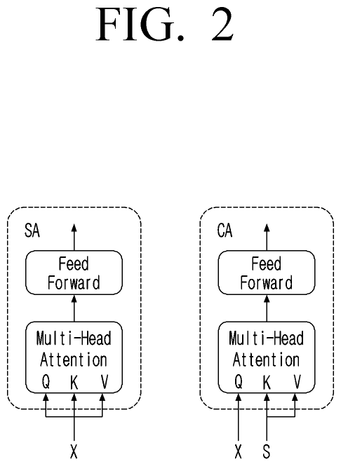

FIG. 2 is a schematic diagram illustrating how self-attention (SA) and cross-attention (CA) work. The self-attention (SA) block takes in an input X, which may be formed of a query Q, value V, and key K, and processes the input using the following:

$$Q = X \cdot {W}_{q} ;$$

$$K = X \cdot {W}_{k} ;$$

$$V = X \cdot {W}_{v}$$

$$SA ( Q , K , V ) = soft max ( \frac{{QK}^{T}}{\sqrt{d}} ) V ,$$

where X is the input feature, W_{q}, Wₖ, and Wᵥ projection heads. The cross-attention (CA) block takes in two inputs—X and S—and processes them using the following:

$$Q = X \cdot {W}_{q} ;$$

$$K = S \cdot {W}_{k} ;$$

$$V = S \cdot {W}_{v}$$

$$CA ( Q , K , V ) = soft max ( \frac{{QK}^{T}}{\sqrt{d}} ) V ,$$

where S is the support features of the support data from the user for the model personalization and Q is the current query instance.

During deployment the high-level assumption made by many domain adaptation frameworks is that the following are available: a predictive model f_{ψ} and an unlabeled target dataset xₛ whose label-space is the same as that of the pre-trained model. Given these, source-free DA approaches define some algorithm A that ultimately leads to classifying a test instance x_{q} as y_{q}≈ [symbol] =A(x_{q}, xₛ, ψ) There are numerous existing algorithms for this. For example, pseudo-label strategies proceed by estimating labels [symbol] for the target set xₛ, treating these as ground-truth, backpropagating to update the model ψ′ such that it predicts [symbol] , and then classifying the test point as f_{ψ′}(x_{q}). The present techniques address the feed-forward setting where algorithm A should not use backpropagation. For example, BN-based approaches use the target set xₛ to update the BN statistics in ψ as ψ′ and then classify the test point as f_{ψ′}(x_{q}).

While the conventional domain adaptation setting assumes that x_{q} and xₛ, are all drawn from a common distribution, the latent domain assumption has no such requirement. For example, xₛ may be drawn from a mixture distribution and x_{q} may be drawn from only one component of that mixture. In this case only a subset of elements in xₛ may be relevant to adapting the inference for x_{q}.

Rather than explicitly updating model parameters, the present techniques define a flexible inference routine f_{ψ} that processes both x_{q} and xₛ to produce [symbol] in a feed-forward manner, i.e., [symbol] =A(x_{q}, xₛ, ψ)=f_{ψ}(x_{q}, xₛ). In the present techniques, there is no requirement that all x_{q} and xₛ are drawn from the same distribution. Instead, the present techniques require robustness to irrelevant elements in xₛ.

To train a model than can be used as described above, the present techniques follow an episodic meta-learning paradigm. This refers to training f_{ψ} using a set of simulated domain adaptation tasks. At each iteration, a task is generated with a unique pair of query and support instances (xₛ, (y_{q}, x_{q})) keeping label space the same across all tasks. Training episodes are simulated where xₛ contains instances with varying relevance to x_{q}. The goal is for f_{ψ} to learn how to select and exploit instances from xₛ in order to adapt inference for x_{q} to better predict y_{q}.

In particular, a task sampler defines each task as having support examples uniformly sampled across a random set of N_{d} domains, with the query example being from one of these domains. More formally, each task can be defined as:

$$T = \{ \{ {x}_{s , 1} , {x}_{s , 2} , … \text{?} \} , {x}_{q ,} {y}_{q} \}$$

$$\text{?} \text{indicates text missing or illegible when filed}$$

for Nₛ unlabelled support examples xₛ. And query example x_{q} with label y_{q}.

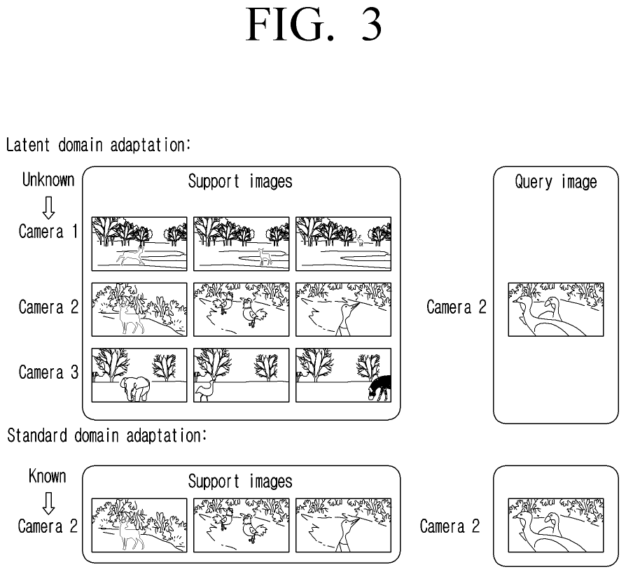

An example task is shown in FIG. 3 having K=3 domains with Nₛ=9 support examples and N_{q}=1 query example. FIG. 3 illustrates how latent domain adaption tasks are structured, and how the structure compares to standard domain adaption. Support images come from a variety of domains and do not have any class or domain labels. The query images come from one of the support domains. The chosen example comes from the real-world iWildCam dataset, where cameras at different locations are meant to act as different domains. This is challenging, as the present training and inference techniques are not provided with this domain/camera annotation in the Latent DA setting, and must learn to estimate relevance. On the other hand, it can be seen from this example that sometimes images from the same annotated domain (for example, the same camera type) are not very similar, and conversely images from other domains may be quite similar. It may be possible for a model in this setup to do better than standard observed-domain that assume an external process only provides same-domain data for adaptation.

The goal is to train a model that can adapt to relevant examples from the support set and obtain superior performance on the query examples. This can be formalised using the following objective:

$${min}_{θ , ϕ , ω} \hat{ε} ( θ , ϕ , ω ) = {E}_{pz} [ \text{?} [ \frac{1}{{N}_{q}} \text{?} l ( {f}_{ϕ} ( \text{?} ( {x}_{q , k} ; {x}_{s} ) , {y}_{q , k} ) ) ] ] , \qquad ( 1 )$$

$$\text{?} \text{indicates text missing or illegible when filed}$$

where ψ={θ, ϕ, ω} are the parameters of the feature extractor, classifier and cross-attention module respectively (described in detail next), xₛ are the support examples used for adaptation, while x_{q} are the query examples for which predictions are made and come from domain z. There are N_{q} query examples. \hat{ε} represents the adaptive risk, which has been theoretically discussed in Zhang et al and can generally be understood as the error after adapting the model for a specific domain.

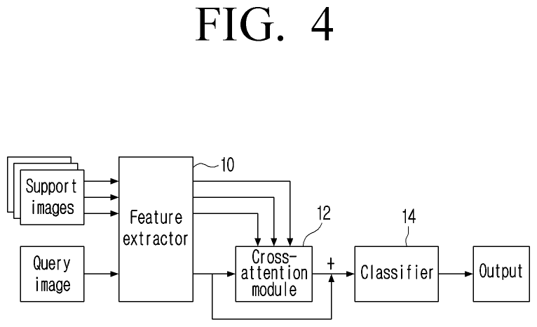

The key to solving Eq. 1 is defining an architecture f_{ψ} that can identify and exploit relevant support instances within xₛ. The solution of the present techniques relies on cross-attention between query and support images, as illustrated in FIG. 4. FIG. 4 is a schematic diagram illustrating the inference method of the present techniques. More specifically, the diagram shows how cross-attention is used within the overall architecture of the present techniques. Although the inputs are shown as being images, it will be understood that the inputs may be any data, and the outputs may take any suitable form.

First, the support and query examples are embedded using the feature extractor 10 of the ML model, after which the embeddings are passed through the cross-attention module 12. The cross-attention module 12 outputs transformed query examples that are then added to the embeddings of the query examples as a residual connection, after which the classifier module 14 makes predictions.

Given a test instance x_{q} and a memory buffer {xₛ}, the model predicts the label y_{q}=f_{ψ}(x_{q,s}) where ψ summarises all model parameters.

Cross-attention module. Given a set of support examples xₛ and query examples x_{q}, the feature extractor f_{θ} 10 is used to extract features f_{θ}(xₛ)−f_{θ}(x_{q}). Cross-attention module CA_{ω}(f_{θ}(xₛ)·f_{θ}(x_{q})) 12 parameterized by ω then transforms query embeddings f_{θ}(x_{q}), using support embeddings f_{θ}(xₛ) as keys. The output of the cross-attention module 12 is added to the query example features as a residual connection, which is then used by the classifier f_{ϕ} to predict labels of the query examples y_{q}=f_{ϕ}(f_{θ}(x_{q})+CA_{ω}(f_{θ}(xₛ)·f_{θ}(x_{q}))).

The cross-attention module itself performs image-to-image cross-attention, rather than patch-to-patch. More specifically, after extracting the features all spatial dimensions and channels are flattened into one vector, which represents the whole image. Image-to-image attention is more suitable for domain adaptation than patch-based option because the overall representation should better capture the nature of the domain rather than a patch. A benefit of image-to-image attention is also that it is significantly more efficient—the whole image is attended to rather than patches, which makes the overall computations manageable even with more images.

The cross-attention module 12 is parameterized by a set of learnable projection matrices w_{q}, wₖ, wᵥ (all of size

$${R}^{C \times ( \frac{C}{R} )} )$$

with additional projection matrix

$$W ∈ {R}^{( \frac{C}{R} ) \times C}$$

to transform the queried outputs (all of these parameters are referred to collectively as ω). The output of the feature extractor f_{θ} is flattened into one vector (any spatial information is flattened), giving C channels, so f_{θ}(x_{q})∈R^{N}^{_{q}}^{×C}, f_{θ}(xₛ)∈R^{N}^{ₛ}^{×c}. The ratio R is also specified, which allows rectangular projection matrices with fewer parameters to be used, which improves efficiency and also provides regularization.

Formally CA_{ω} is expressed as:

$$q = {f}_{θ} ( {x}_{q} ) {W}_{q} ,$$

$$k = {f}_{θ} ( {x}_{s} ) {W}_{k} ,$$

$$v = {f}_{θ} ( {x}_{s} ) {W}_{V} ,$$

$$A = soft max ( {qk}^{T} / \sqrt{\frac{C}{h}} ) ,$$

$$C \text{?} ( {f}_{θ} ( {x}_{s} ) ; {f}_{θ} ( {x}_{1} ) ) = Av .$$

$$\text{?} \text{indicates text missing or illegible when filed}$$

Similarly as CrossViT and self-attention more broadly, multiple heads h are used, so it is referred to as MCA. Layer normalization is used, as is the common practice. The output of MCA is added to the query example embeddings as a residual connection:

$$z = {f}_{thea} ( {x}_{q} ) + MC \text{?} ( LN ( {f}_{θ} ( {x}_{s} ) ) ; LN ( {f}_{θ} ( {x}_{q} ) ) ) ) ,$$

$$\text{?} \text{indicates text missing or illegible when filed}$$

which is then passed through the classifier f_{θ} to obtain predictions ŷ=f_{θ}(z). Following CrossViT, a feed-forward network is not applied after cross-attention. Instead the output is directly added via residual connection and pass it to the classifier.

The cross-attention module 12 is broadly inspired by the CrossViT cross-attention module, but it has several key differences to make it suitable for the desired application: cross-attention is applied 1) between support and query images from different domains, 2) image-to-image rather than patch to patch, 3) on extracted features right before the classifier layer.

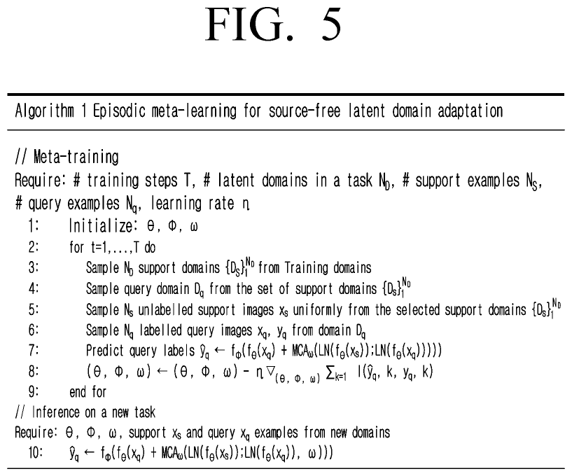

Meta-learning. The main model (composed of the feature extractor f_{θ} and classifier f_{ϕ} and the cross-attention module (parameterized by ω) is trained by meta-learning across many tasks. Each task has the structure described above. Meta-learning is computationally efficient in this case because the inner loop does not include back-propagation based optimization—the adaptation to the support examples is done purely feed-forward. The details of the present approach is shown in FIG. 5. FIG. 5 shows an algorithm for episodic meta-learning for source-free latent domain adaption. The following summarises how meta-training and inference (meta-testing) are done:

Step 1: Initial Training, (prior to deployment): Given a backbone model (e.g., a convolutional neural network), a cross-attention module is injected before the classifier layer. During the model training, the whole model is meta-trained using episodes, which are constructed by pairing samples to classify (aka query samples) with a memory container full of support samples. For a given query sample (e.g., speech data in context of sport background noise), the set of support samples (e.g., audio clips from office, home, or commuting contexts) are of mixed relevance according to similarity between their distributions, which is unknown. To select relevant support samples to assist inference, the cross-attention module computes an instance-to-instance feature correlation vector between the query and support samples. The cross-attention module generates a new feature for the query instance which is then classified. The cross-attention module is then trained so as to learn to select relevant support instances and extract information from them to correctly classify query instances.

Step 2: On-Device Adaptation: The memory container is populated with unlabelled user data by any process such as: explicit upload, or automatic sliding window, or FIFO buffering of user data. To process new test (aka query) instance, the feature is extracted and compared against features of the support samples in the memory container by cross-attention. This generates an updated feature for the query instance, which is then classified.

The present techniques may be expanded in the following ways.

Meta-data may be available for each instance, e.g., GPS coordinate, or time-of-day stamp. In this case query instances are assumed to provide (x_{q}, z_{q}) and support instances (xₛ, zₛ). Such meta-data can be used to improve adaptation by extending the cross-attention block. This allows the model to learn if/how to prioritize adapting to memory container data with similar meta-data than the current query example. Cross-attention (CA) block now uses Z to represent corresponding meta-data as follows, where [,] indicates concatenation.

$$Q = [ X , {z}_{q} ] \cdot {W}_{q} .$$

$$K = [ S , {Z}_{s} ] \cdot {W}_{k} .$$

$$V = S \cdot {W}_{v} ,$$

$$CA ( Q , K , V ) = soft max ( \frac{{QK}^{T}}{\sqrt{d}} ) V ,$$

In case nothing in the support set is relevant, and detrimental adaptation arises as a risk. This situation could be detected, and adaptation rejected, by checking

$$max ( soft max ( \frac{{QK}^{T}}{\sqrt{d}} ) ) < τ .$$

For threshold τ. In this case model reverts to factory setting and does not perform any worse due to inappropriate adaptation.

The cross-attention framework of the present techniques is a general module that can apply to enhance any supervised learning task across multiple domains.

Thus, the present techniques provide a computer-implemented method to train, using a server, a machine learning, ML, model to perform personalised visual or audio analysis, the method comprising: obtaining a first training dataset comprising a plurality of query data items that represent data items to be analysed by the ML model, and a second training dataset comprising a plurality of support data items that represent data items with varying degrees of similarity to the query data items; and inputting tuples of data items into a cross-attention module of the ML model, the tuples of data items comprising a data item from each of the first and second training datasets, and training the cross-attention module to: compare, for each tuple, a feature of the query data item and features of the support data item(s) in each tuple; and select, using the comparing, at least one support data item that is most similar to each query data item. The term “tuple” is used herein to mean a set of two or more elements. In some cases, the tuple may have two elements, i.e. a data item taken from each of the first and second training datasets. In other cases, the tuple may have more than two elements, i.e. a data item taken from the first training dataset, and a set of support data items taken from the second training dataset.

To determine the similarity between the query data item and the support data item(s) in each tuple, the method may comprise extracting, using a feature extractor, at least one feature from each data item in the tuple. In some cases, the data items in the tuple may contain or comprise meta-data. For example, the meta-data may be location information, or time and/or date information. To make use of this meta-data during the training, the meta-data of a data item may be concatenated with the extracted feature(s) of that data item. The training method may further comprise training the cross-attention module to compare the extracted feature(s) of the query data item that is (are) concatenated with meta-data of the query data item, and the extracted features of the support data items that are concatenated with their meta-data.

Comparing features of the query data item and support data item may comprise comparing the query and support data items as whole data items. For example, in the case of the data items in each tuple being images, the training method may comprise comparing the images, rather than comparing patches of the images. A benefit of image-to-image attention is also that it is significantly more efficient—the whole image is attended to rather than patches, which makes the overall computations manageable even with more images.

The training method may further comprise training the cross-attention module to generate a feature representation for each query data item using the selected at least one support data item that is most similar, wherein the generated feature representation is input into a classifier module of the ML model.

The training method may further comprise training the cross-attention module to not generate a feature representation for a query data item when no support data item is identified as being similar. This is useful because it avoids or prevents negative transfer. That is, when none of the support data items are relevant (e.g. similar to the query data item), using any of the support data items may lead to detrimental adaptation of the ML model. The present techniques avoid this by processing a query data item without information taken from the support data items in cases when the support data items are dissimilar to the query data item.

In some cases, the support data items and query data items may be images, and the ML model may be trained to perform image analysis. In other cases, the support data items and query data items may be audio files, and the ML model may be trained to perform audio analysis.

Experimental Results. The present techniques are evaluated on a variety of synthetic and real-world benchmarks, namely FEMNIST, CIFAR-C (TinyImageNet-C, and iWildCam. All of these benchmarks have a large number of domains, e.g. around 100 for CIFAR-C and TinyImageNet-C and around 300 for FEMNIST and iWildCam. A brief description of each benchmark is provided:

The FEMNIST dataset includes images of handwritten letters and digits, and is derived from the EMNIST dataset by treating each writer as a domain.

The CIFAR-C extends CIFAR-10 by a applying a variety of corruptions such as different brightness, snow or various types of blurring. There are different levels of severity with which the corruptions are applied, giving rise to multiple domains for the different levels.

TinyImageNet-C is an extension of TinyImageNet, that has been extended in a manner analogous to CIFAR-C.

iWildCam is a large-scale real-world dataset that includes images of different animal species taken by cameras in different locations. There is a lot of variability in the style of images in different cameras, for example different illumination, camera angle or vegetation. The dataset has also substantial class imbalance, so F1 score needs to be used for evaluation.

For FEMNIST, CIFAR-C and TinyImageNet-C the splits into meta-training, meta-validation and meta-testing splits as selected in Zhang et al are followed. For iWildCam the splits of domains selected in Koh et al, are followed. Additionally for iWildCam all domains that have fewer than 40 examples are filtered out.

Empirical risk minimization or ERM is a baseline that simply trains on all training domains and performs no domain adaptation. It is known to work surprisingly well and is often difficult to beat when properly tuned. In the present experiments, it is trained following the episodic pipeline for fair comparison i.e. it is directly trained using the query examples during meta-training.

A simple and often useful method for source-free domain adaptation is to update the batch normalization (BN) statistics using the unlabelled target domain data. It has achieved strong results in conventional SFDA. However, in the latent DA setting it is unclear if statistics calculated across a support set of varying relevance will be helpful for achieving better performance. During evaluation, the statistics are updated using all support examples, and directly used for the query examples.

Contextual meta-learning (CML) is the main instantiation of ARM (Zhang et al) as a way to extract information from the whole minibatch in test-time adaptation and use it to obtain better performance on test images. The CML is applied on the whole support set with images from different domains and then use it as additional information for making predictions on test images. CML is a feed-forward domain adaptation method, but it has not been designed for the latent domain adaptation problem.

The present techniques are also referred to herein as “cross-attention domain adaption” or CXDA. The present cross-attention module first flattens all spatial information and channels into one vector for each image, so it works image-to-image. In line with existing literature the present techniques use 8 heads and layer normalization on the flattened features of support and query images. The use of layer normalization means that the present approach does not rely on a minibatch of query examples i.e. it natively supports streaming mode and does not need multiple query examples to obtain strong results, unlike existing test-time domain adaptation approaches.

Support images are projected into keys and values, while query images act as queries for cross-attention after transformation by a projection matrix. After calculating the attention map and applying it to the values, the output is multiplied by a further projection matrix. Only one cross-attention layer is used and the projection matrices have rectangular shape of C×C/2 where C is the dimensionality of the flattened features. No dropout is used. The output of cross-attention module is directly added to the query features via residual connection.

Weak data augmentation is used during meta-training. The exact augmentations are cropping, horizontal flipping, small rotations (up to 30 degrees) and are different from the corruptions tested in some of the benchmarks. These are applied with probability 0.5 independently.

The tasks in the experiments have 5 support domains, with 20 examples in each, overall 100 support examples. Query examples come from one randomly selected support set domain (out of 5 options) and there are 20 of them. Note that the method fully supports streaming mode, so no statistics are calculated across the batch and it works independently for each. The exact number of tasks for meta-validation and meta-testing is 420 validation and 420 test for FEMNIST, 850 validation and 11000 test for CIFAR-C, 1700 validation and 11000 test for TinyImageNet-C, and 745 validation and 2125 test tasks for iWildCam.

For training, the hyperparameters selected in Zhang et al for FEMNIST, CIFAR-C and TinyImageNet-C are used, and the cross-attention parameters are trained with the same optimizer. For FEMNIST and CIFAR-C a small CNN model is used, while for TinyImageNet-C a pre-trained ResNet-50 is fine-tuned. For iWildCam the hyperparameters selected in Koh et al are used, but with images resized to 112×112, training for 50 epochs and with mini-batch size resulting from the present task design (100 support and 20 query examples). During evaluation, batch normalization statistics are frozen, except for the BN baseline where they are updated using the support examples. All the experiments are repeated across three random seeds.

Zhang et al is followed in reporting average and worst performance over all testing episodes. While Zhang et al reports the worst single episode, this metric is modified here to report the average performance of the worst decile of episodes. The reason is that for some benchmarks, among all 10,000 test tasks with varying domain transfer difficulty there can easily be at least one episode with zero accuracy.

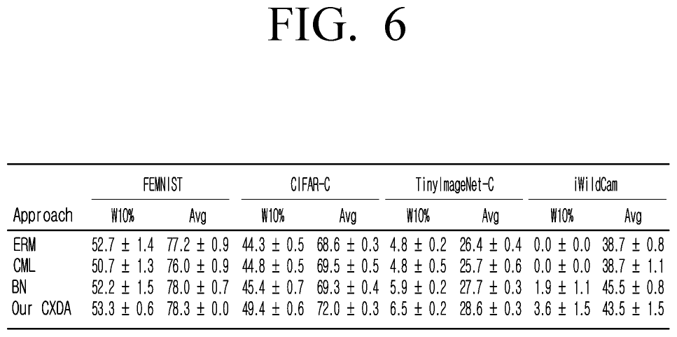

FIG. 6 is a table showing experimental results comparing the present techniques with existing models. The table shows the main benchmarks: average and worst-case (worst 10% tasks) test accuracy, with standard error of the mean across 3 random seeds. The results are shown in FIG. 6 for the benchmarks: FEMNIST, CIFAR-C, TinyImageNet-C, and large-scale real-world iWildCam. The results shown both average performance as well as reliability via the worst case performance, with the present bottom performing decile tasks. From the results it can be seen that the present cross-attention approach (CXDA) results in consistent improvements over the strong ERM baseline across all benchmarks, as well as the CML and BN baselies. The encouraging result on iWildCam highlights that the present method works well in practical real-world scenarios.

Overall it is seen CML and BN strategies that naively combine information from all support examples (including both domain relevant and domain irrelevant) are only helpful in some of the cases and do not lead to consistent improvements. This highlights the need to adaptively select the right examples from the support set when they come from domains of mixed relevance. The results confirm that the present mechanism based on cross-attention can successfully select useful information from the set of examples with both relevant and irrelevant examples, and ultimately achieve superior performance.

As part of the analysis, several questions are considered: 1) How does the performance of unsupervised cross-attention compare with a supervised version? 2) How does the inference and training time compare for the present cross-attention method and the baselines? 3) How does performance vary with the degree of relevance between the support set and the test/query instances? 4) What do the attention weights look like?

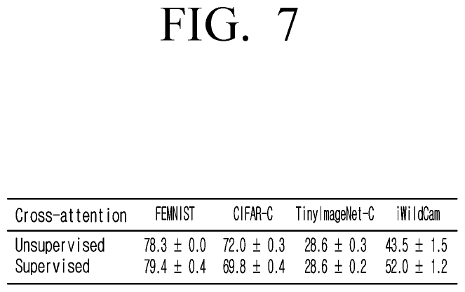

Domain-supervised vs domain-unsupervised adaptation: Recall that the main CXDA algorithm (FIG. 5) and experiments above are domain unsupervised. This may induce a cost due to distraction by domain-irrelevant adaptation data (e.g., as observed by CML underperforming ERM previously) or a potential benefit due to enabling transfer. We therefore compare our unsupervised method with a domain-supervised alternative, with manually defined attention weights based on domain labels. FIG. 7 is a table showing the experimental performance of the present techniques with unsupervised and supervised cross-attention. The table shows a comparison of unsupervised and supervised cross-attention on the benchmarks. Average test accuracy (%) for all benchmarks apart from iWildCam where F1 score is reported. FIG. 7 shows the results are dataset dependent, which suggests that for some datasets it is useful to use soft cross-attention weights given by a model that automatically learns to which examples give more weight. FIG. 7 shows the results are dataset dependent. The fact that in at least some cases domain-unsupervised adaptation outperforms the supervised case shows that the benefit can sometimes outweigh the cost, and that it is possible for a suitable model to outperform manual domain annotations.

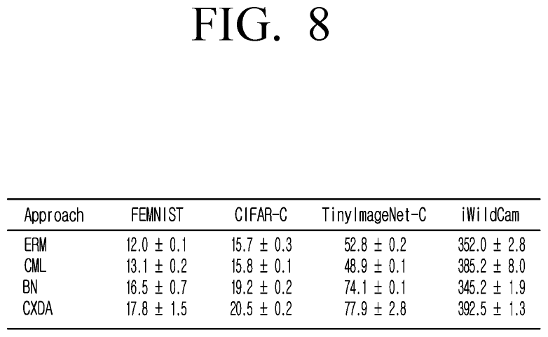

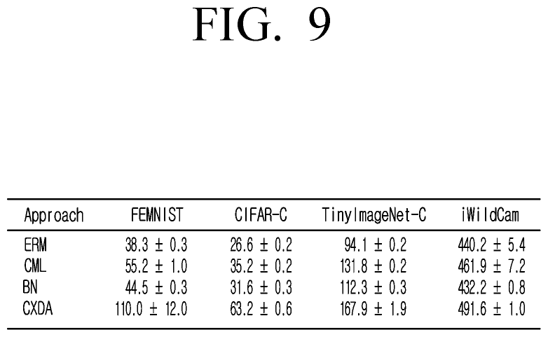

Comparison of inference and training times: The experiments also show that the present techniques provide a model that is fast and can do adaptation quickly in FIG. 8, with inference time very similar to the baselines. FIG. 8 is a table showing speed of the present techniques and existing models. The table shows inference time, i.e. the average time in ms per task, with standard error of the mean (SEM) across 3 seeds. FIG. 9 is a table showing run time of the present techniques and existing models. The table shows total run time, i.e. average time in minutes, with SEM across 3 seeds. FIG. 9 shows that meta-training is longer for the smaller datasets, but the difference is small for large datasets and models. All experiments within the same benchmark used the same GPU, number of CPUs and total available memory.

The present cross-attention approach is fast in the desired scenario when there are tens or hundreds of images available for adaptation (in the experiments, 100 are used). Similarly as for attention more broadly, its computational costs depend on the number of examples and the approach would be expensive if there were e.g. many thousands or millions of examples in the support set. In these cases a simple solution would be to take a random subset of images for adaptation, perhaps with more preference for the recent ones, considering the typical practical use-case of the preset set-up.

The present approach is designed to be practically useful and help obtain better performance in settings which are underrepresented in the training data. Hence, it can be expected to empower underrepresented communities. However, it also means that it can improve performance for applications of machine learning that have negative implications.

Thus, the present techniques provide a model that can be personalised/adapted using examples that come from a mixture of domains and are without domain or class labels. To answer this new highly challenging adaptation problem, the present techniques provide a novel solution based on cross-attention that is able to automatically select relevant examples and use them for adaptation on the fly.

The present techniques have a number of applications.

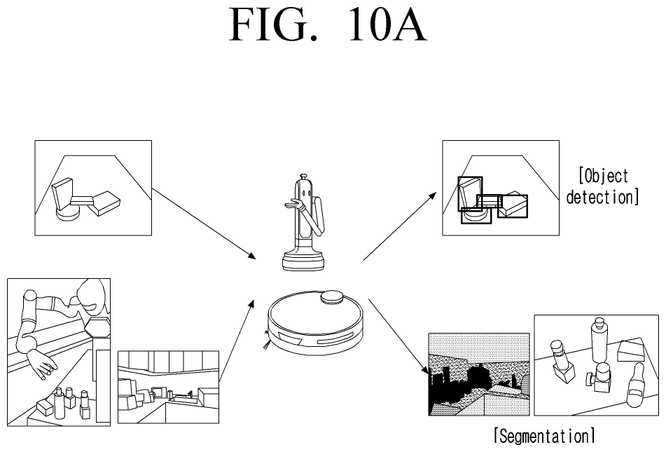

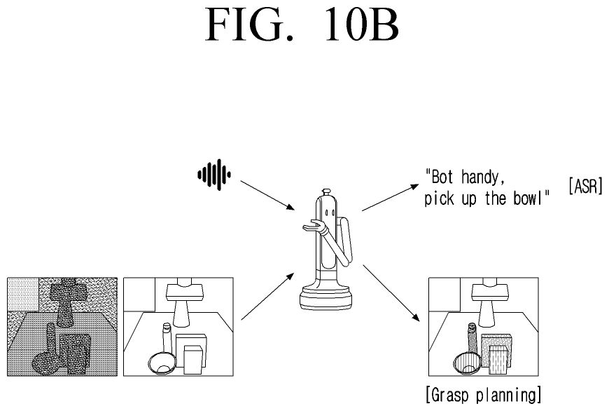

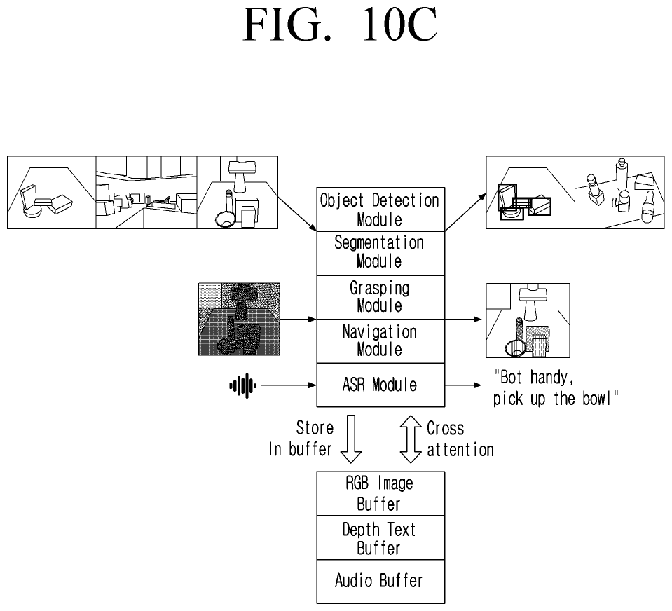

For example, the algorithm may improve robots. A robot such as a vacuum or household assistant relies on a number of AI modules, as shown in FIGS. 10A and 10B. However, performance is poor when robots are deployed to a new household, which inevitably looks different from the environment used to train the robot's AI modules. With the present techniques, the robot can be deployed to new environments and automatically adapt its grasp planner in real-time without back-propagation.

Robot devices must process data from a variety of sensors for a variety of tasks, as shown in FIGS. 10A and 10B. Example AI based services underpinning robot:

Object detection (localization up to bounding box) in order to detect objects to avoid so vacuum doesn't crash.

Semantic segmentation (pixel-wise classification) in order to navigate, and more precisely localize objects to avoid, or to tidy up.

Speech recognition (ASR), in order to understand instruction form human user.

Grasping. Once robot endowed with an arm (e.g., bot handy) has detected an object that should be picked up, it needs to work out how to position its arm and gripper in order to successfully pick up the object. It runs a predictive model to estimate how to position their gripper/hand in order to grasp any given object. Such a model inputs an RGB-D image and outputs a set of six parameters describing the required position of robot joints before a grasp should be initiated. Such grasp prediction models are highly sensitive to dataset shift degradation

The present techniques can also be used to improve sim2real robot transfer, allowing robots algorithms trained in simulation to perform better when deployed in a physical robot.

FIG. 10C shows how the present techniques may be used to enhance the functionality of a robot device. Each module would store a window of recent unlabelled data in the memory container/buffer, and then perform cross-attention between the current query/test instance and the memory buffer in order to improve all functionality.

A robot exploiting the present techniques simply accumulates a buffer of data for the new environment in the memory container. If the AI services on the robot exploit the present feed-forward adaptation framework, personalization of the robot to the new environment is automatic.

If the robot's owner re-arranges furniture, re-paints the house, or moves to a new house, adaptation to the new environment is also automatic and transparent.

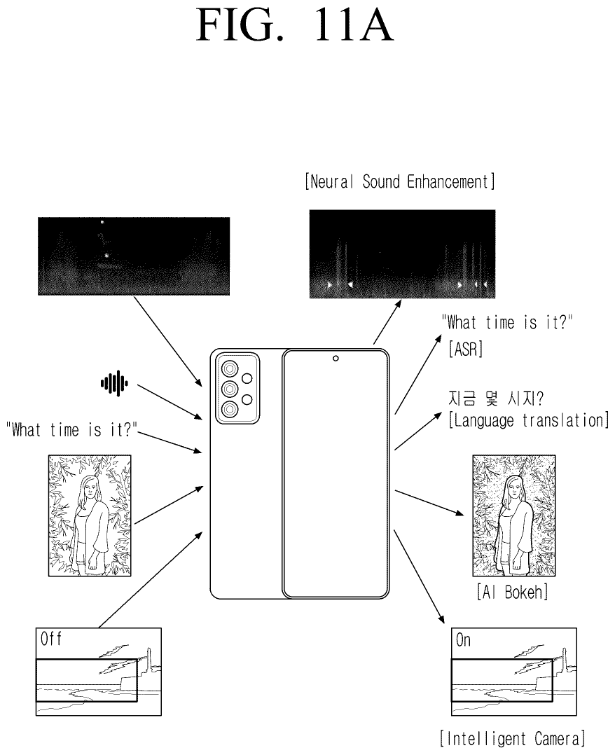

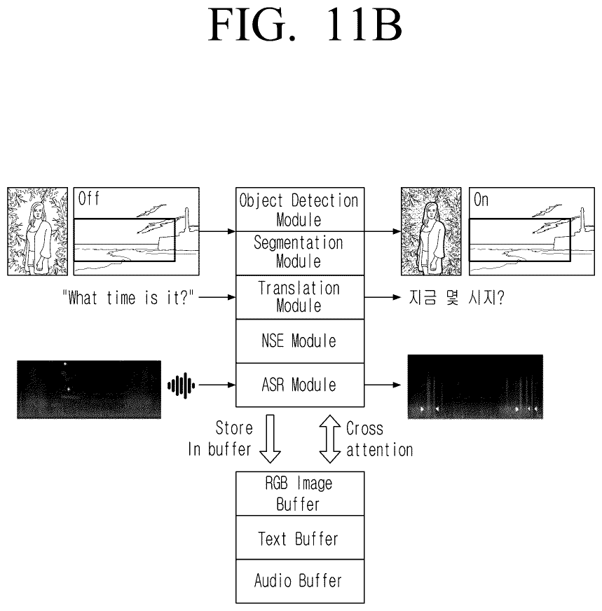

Another example application is smartphones. The present adaptation algorithm may improve smartphones. Smartphones now provide several AI-based features. FIG. 11A shows how smartphones process data from a variety of sensors for a variety of tasks. For example: audio enhancement/noise suppression; speech recognition; language translation; software Bokeh (depends on semantic segmentation, etc.); and intelligent camera (depends on scene recognition, etc.). The present techniques can also be used to improve all AI software features. For example, if user moves between home/office/gym/commuting within one day, functionality such as PSE and ASR could automatically update to adapt to the different background noise characteristics of each of these environments.

FIG. 11B shows how the present techniques may be used to enhance the functionality of a smartphone. In the present techniques, each module would store a window of recent unlabelled data in the memory container/buffer, and then perform cross-attention between the current query/test instance and the memory buffer in order to improve all functionality.

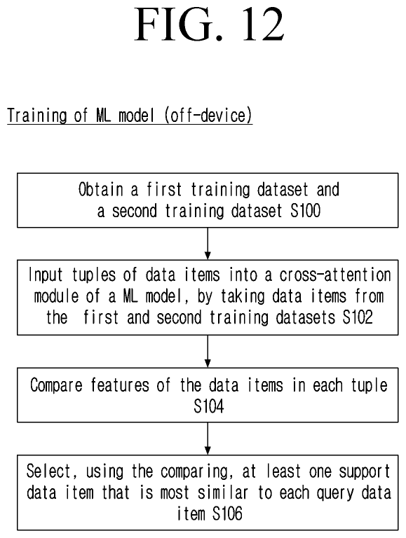

FIG. 12 is a flowchart of example steps to train a model that is capable of adaptation. The method, which may be performed using a server, comprises: obtaining a first training dataset comprising a plurality of query data items that represent data items to be analysed by the ML model, and a second training dataset comprising a plurality of support data items that represent data items with varying degrees of similarity to the query data items (step S100); inputting tuples of data items into a cross-attention module of the ML model, the tuples of data items comprising a data item from each of the first and second training datasets (step S102); and training the cross-attention module to: compare, for each tuple, a feature of the query data item and features of the support data item in each tuple (step S104); and select, using the comparing, at least one support data item that is most similar to each query data item (step S106). Further details of the training process have been described above, and are not repeated.

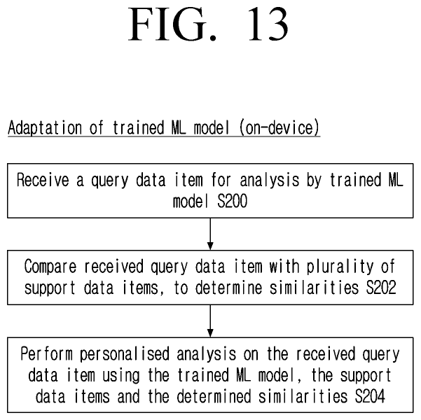

FIG. 13 is a flowchart of example steps to dynamically adapt the trained model at inference time on-device. The method comprises: receiving a query data item for analysis by the trained ML model (step S200); comparing the received query data item with a plurality of support data items stored on the electronic device to determine a similarity between the received query data item and each of the support data items (step S202); and performing personalised analysis on the received query data item, using the trained ML model, using the support data items and the determined similarity (step S204). Further details of the inference time process have been described above, and are not repeated.

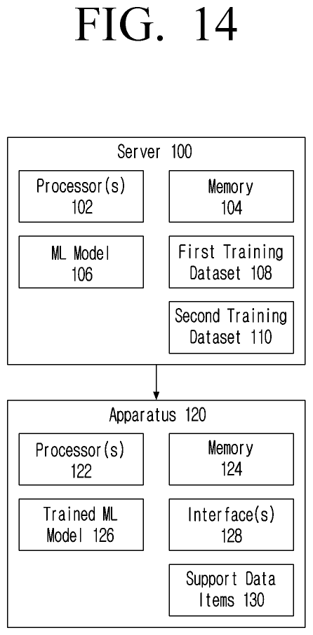

FIG. 14 is a block diagram of a system for training and using a model that is adaptable on-device. The system comprises a server 100 and a plurality of apparatus/electronic devices 120. Only a single apparatus 120 is shown here for the sake of simplicity.

The server 100 comprises at least one processor 102 coupled to memory 104. The server is used to train a ML model 106. The server 100 comprises a first training dataset 108 comprising a plurality of query data items that represent data items to be analysed by the ML model, and a second training dataset 110 comprising a plurality of support data items that represent data items with varying degrees of similarity to the query data items.

The processor 102 may be arranged to: input tuples of data items into a cross-attention module of the ML model, the tuples of data items comprising data items from each of the first and second training datasets; and train the cross-attention module to: compare, for each tuple, a feature of the query data item and features of the support data items; and select, using the comparing, at least one support data item that is most similar to each query data item.

Once the ML model has been trained, it may be provided to a plurality of apparatuses 120. The apparatus 120 comprises at least one processor 122 coupled to memory 124 and arranged to: receive a query data item for analysis by the trained ML model 126; compare the received query data item with a plurality of support data items 130 stored on the electronic device to determine the similarities between the received query data item and the support data items; and perform personalised analysis on the data item, using the trained ML model, using the support data items and the determined similarities. The apparatus 120 may comprise an interface 128 to receive the query and support data items. For example, the interface 128 may be a camera for capturing images or a microphone for capturing audio, or similar.

The at least one processor 122 may comprise one or more of: a microprocessor, a microcontroller, and an integrated circuit. The memory 124 may comprise volatile memory, such as random access memory (RAM), for use as temporary memory, and/or non-volatile memory such as Flash, read only memory (ROM), or electrically erasable programmable ROM (EEPROM), for storing data, programs, or instructions, for example. The at least one processor 122 is arranged to perform the steps of FIG. 13.

### REFERENCES

Vaswani et al—Ashish Vaswani, Noam Shazeer, Niki Parmar, Jakob Uszkoreit, Llion Jones, Aidan N. Gomez, Lukasz Kaiser, and Illia Polosukhin. Attention is all you need. In NeurIPS, 2017
CrossVIT—Chun-Fu Chen, Quanfu Fan, and Rameswar Panda. CrossViT: Cross-attention multi-scale vision transformer for image classification. In ICCV, 2021
Non-parametric transformers-Jannik Kossen, Neil Band, Clare Lyle, Aidan N. Gomez, Tom Rainforth, and Yarin Gal. Self-attention between datapoints: Going beyond individual input-output pairs in deep learning. In NeurIPS, 2021
Zhang et al—Marvin Zhang, Henrik Marklund, Nikita Dhawan, Abhishek Gupta, Sergey Levine, and Chelsea Finn. Adaptive risk minimization: learning to adapt to domain shift. In NeurIPS, 2021
Koh et al—Pang Wei Koh, Shiori Sagawa, Henrik Marklund, Sang Michael Xie, Marvin Zhang, Akshay Balsubramani, Weihua Hu, Michihiro Yasunaga, Richard Lanas Phillips, Irena Gao, Tony Lee, Etienne David, Ian Stavness, Wei Guo, Berton Earnshaw, Imran Haque, Sara M Beery, Jure Leskovec, Anshul Kundaje, Emma Pierson, Sergey Levine, Chelsea Finn, and Percy Liang. Wilds: A benchmark of in-the-wild distribution shifts. In ICML, 2021
Pre-trained ResNet-50—Kaiming He, Xiangyu Zhang, Shaoqing Ren, and Jian Sun. Deep residual learning for image recognition. In CVPR, 2015
FEMNIST—Caldas, S., Duddu, S. M. K., Wu, P., Li, T., Konecny J., McMahan, H. B., Smith, V., and Talwalkar, A. (2018). LEAF: A benchmark for federated settings. In Workshop on Federated Learning for Data Privacy and Confidentiality

CIFAR-10—Krizhevsky, A. (2009). Learning multiple layers of features from tiny images. Technical report

CIFAR-C—Hendrycks, D. and Dietterich, T. (2019). Benchmarking neural network robustness to common corruptions and perturbations. In ICLR

TinyImageNet-C—Le, Ya and Yang, Xuan: Tiny imagenet visual recognition challenge. In CS 231N, 2015.
iWildCam—Beery, S., Cole, E., and Gjoka, A. (2020). The iWildCam 2020 competition dataset. In arXiv

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

1. A computer-implemented method for performing personalised visual or audio analysis, on an electronic device using a trained machine learning, ML, model, the method comprising:
receiving a query data item for analysis by the trained ML model;
comparing the received query data item with a plurality of support data items stored on the electronic device to determine a similarity between each of the received query data item and the support data items; and
performing personalised analysis on the received query data item, using the trained ML model, the support data items and the determined similarities.

2. The method as claimed in claim 1 further comprising:
extracting, using a feature extractor of the trained ML model, at least one feature from the received query data item and the plurality of support data items.

3. The method as claimed in claim 1 wherein the comparing comprises:
using a trained cross-attention module of the trained ML model to determine a similarity between the received query data item and each of the support data items.

4. The method as claimed in claim 1 wherein the comparing comprises:
comparing meta-data of each support data item with meta-data of the received query data item.

5. The method as claimed in claim 4 further comprising:
concatenating the meta-data of each support data item with the at least one extracted feature of the support data item, and concatenating the meta-data of the received query data item with the at least one extracted feature of the query data item;
wherein comparing meta-data comprises comparing the extracted features that are concatenated with the meta-data.

6. The method as claimed in claim 3 further comprising:
generating, using the determined similarities, a feature representation for the received query data item for use by the trained ML model to perform personalised analysis on the received query data item.

7. The method as claimed in claim 6 wherein the generating comprises:
using at least one feature from at least one support data item to modify the original feature representation for the received query data item, wherein the at least one feature is from the at least one support data item that is similar to the received query data item.

8. The method as claimed in claim 3 wherein when no support data item is determined to have sufficient similarity with the received query data item, the personalised analysis is performed using the trained ML model and the original feature representation of the received query data item.

9. The method as claimed in claim 1 wherein comparing the received data item with a plurality of support data items stored on the electronic device comprises using all of the plurality of support data items.

10. The method as claimed in claim 1 wherein comparing the received data item with a plurality of support data items stored on the electronic device comprises using a subset of the plurality of support data items when using all of the plurality of support data items would increase a time required to perform the comparing.

11. The method as claimed in claim 1 wherein the plurality of support data items stored on the electronic device are unlabelled data items.

12. The method as claimed in claim 1 wherein the received data item is an image, the plurality of support data items are images, and the trained ML model is trained to perform image analysis.

13. The method as claimed in claim 12 wherein the trained ML model is trained to perform any one of the following image analysis tasks: image classification, object recognition, semantic segmentation, grasp prediction, navigation, and image enhancement.

14. The method as claimed in claim 1 wherein the received data item is an audio data item, the plurality of support data items are audio files, and the trained ML model is trained to perform audio analysis.

15. The method as claimed in claim 14 wherein the trained ML model is trained to perform any one of the following audio analysis tasks: automatic speech recognition, audio enhancement, noise suppression, and language translation.
